(19) United States
(12) Patent Application Publication
(10) Pub. No.: US 2011/0311692 A1
(43) Pub. Date: Dec. 22, 2011

(54) Portable hand-held container for dispensing a food mixture

(76) Inventors: Bradley K. Shepard, Wilmington, NC (US); Melinda W. Shepard, Wilmington, NC (US)

(21) Appl. No.: 12/802,933

(22) Filed: Jun. 17, 2010

(51) Int. Cl. A47J 43/00; B67D 7/76; A23L 1/164; B67D 7/78

(52) U.S. Cl. 426/389; 222/145.1; 222/189.07; 99/516

(57) ABSTRACT

A portable container is described for use in consuming a mixture of cereal and milk. The container includes an open-top receptacle divided into a cereal side and a milk side by an angled divider wall that includes an opening to permit milk to flow between the receptacle's cereal and milk sides, and a lid with a discharge opening in communication with the receptacle cereal side. A spoon-shaped mouthpiece is attached to the outer surface of the lid along the inner side of the discharge opening. In use, cereal and milk are mixed together in the receptacle with the wetted cereal being held on the cereal side of the divider wall. When the container is tilted, excess milk flows to the milk side of the receptacle and wetted cereal slides along the divider wall through the discharge opening and onto the mouthpiece for consumption.

### BACKGROUND OF THE INVENTION

(1) Field of the Invention

The present invention relates to a container and method for holding a mixture of a solid food and a liquid food permitting consumption of the food mixture with draining of excess liquid from the mixture prior to consumption. In particular, the present invention relates to a container for holding a mixture of cereal and milk, whereby the container is tilted to discharge a mixture of cereal and milk through a discharge opening into the user's mouth, while draining excess milk from the mixture prior to discharge of the mixture from the container.

(2) Description of the Prior Art

Dry cereal and milk are one of the most popular breakfast foods, with the milk and cereal being mixed in a bowl and consumed at the breakfast table with a spoon. However, unlike many other breakfast foods, cereal cannot be consumed on-the-go, such as when driving an automobile, or walking.

The prior art contains numerous attempts to provide a way for cereal to be consumed from a one-handed container while engaged in other activities, thereby enabling consumption while engaged in driving, walking, etc., and providing a substantially greater market for cereal products. Generally, the prior art devices designed for this purpose are comprised of a container that is divided into two separate compartments, one for the dry cereal and one for the milk. Discharge openings from each compartment are accessible to the consumer, so that dry cereal and milk can be separately discharged from the container into the consumer's mouth, where the dry cereal and milk are first admixed.

While perhaps being mechanically suitable for their design functions, these devices do not provide the same cereal consumption sensation that is experienced when consuming a mixture of milk and cereal from a bowl. Instead, the sensation is more akin to taking a mouth full of dry cereal and then “chasing” it with a swallow of milk. Thus, there is still a need for a portable, hand-held food container that could contain an admixture of cereal and milk in the same way as a cereal bowl, with the excess milk being drained from the admixture so that a “spoonful” of milk wetted cereal can be eaten by the consumer.

### SUMMARY OF THE INVENTION

Generally, the present invention relates to a portable hand-held food container for use in holding a food mixture of a solid and a liquid, in particular a mixture of dry cereal and milk, so that portions of the mixture can be eaten from the container with excess liquid being separated from said mixture prior to consumption. The cereal and milk is mixed in the container prior to consumption with excess milk being drained prior to being eaten, resulting in a taste sensation much like that experienced when eating cereal with a spoon from a bowl.

The container is comprised of an open-top receptacle having an outer wall and a bottom wall, a top with a cereal admixture discharge opening, and a divider separating the receptacle into a solid side, and a liquid side. The receptacle may be of different shapes. Generally, the preferred container, as illustrated herein, is a tumbler shaped container with a continuous outer wall having a circular cross-section tapering inwardly toward a bottom wall.

A lid extends across the top of the receptacle and may be a screw-on lid or a friction fit lid. Generally, a seal such as an O-ring or other compressible washer is positioned between the lid and the upper edge of the receptacle to ensure a liquid tight seal. The lid has an upper surface and a lower surface with a discharge opening extending through the lid into communication with the solids or food side of the receptacle. The opening has an inner side toward the center of the lid and an outer side toward the lid's periphery.

A divider wall extends downwardly from the bottom surface of the lid adjacent the inner side of the top opening to divide the receptacle into a solids side to hold the dry cereal or other dry food, and a liquid side to hold the milk or other liquid food. The divider wall includes openings that allow milk or other liquid to flow through the divider wall between the solid and liquid sides, but prevents solids from passing from the solid side to the liquid side.

The wall openings may be of different shapes so long as milk readily flows from one side of the wall to the other, without the opening being large enough to permit cereal to pass through the openings. For example, the openings may be vertical or horizontal slots, a plurality of small round openings, etc.

The divider wall desirably extends to adjacent the side or bottom wall of the receptacle, i.e, at or close to a receptacle wall, to prevent cereal from passing beneath the wall to the liquid side. Preferably, the divider wall is comprised of upper and lower sections that may be of approximately equal length to ensure flow of excess milk from the solids side of the receptacle during consumption, while avoiding any interference with the discharge of the wetted food or cereal.

For convenience in consumption and to simulate eating of cereal from a bowl, a spoon-shaped mouthpiece can be attached to the top surface of the lid along the inner side of the discharge opening. Wetted cereal discharged from the discharge opening is then deposited onto the “spoon” where it is eaten by the consumer in the normal way cereal is eaten.

In other to facilitate the discharge of the wetted cereal mixture from the receptacle, and to isolate excess milk from the wetted mixture, an outwardly curved barrier wall can extend downwardly from the outer side of the discharge opening and across the upper section of the divider wall. The outer edges of the barrier wall joins the outer edges of the divider wall upper section to form a conduit that extends from preferably approximately half way into the receptacle to around the discharge opening. The edges of the barrier wall may extend downwardly to form side walls for the permeable section of the divider wall.

In order to maximize the amount of cereal that can be held in the receptacle, the divider wall is preferably angled downwardly toward the liquid side of the receptacle at an angle of up to about 45°, and preferably from about 20° to about 45°, relative to the longitudinal axis of the receptacle. At this angle, sufficient cereal can be placed on the solids side of the divider wall in the bottom of the receptacle, while still enabling the wetted cereal to slide along the solids side of the divider wall when the receptacle is tilted for consumption.

As noted previously, the upper edge of the divider wall is integral with the bottom of the lower surface of the container lid adjacent the inner edge of the discharge opening. Since the discharge opening is offset to adjacent the edge of the lid, the upper edge of the divider wall will also be offset toward the solids side of the receptacle. As a result, additional space is provided in the upper part of the receptacle on the liquid side to hold excess milk when the receptacle is tilted for consumption.

The container may also incorporate several optional features to enhance consumption. For example, when there is a desire to add an additional amount of liquid to the mixture being discharged, a small liquid port may be included in the divider wall adjacent the interface of the wall and lid. Thus, when the receptacle is tilted for consumption the wetted mixture slides along the divider wall and out the discharge opening with a small amount of additional milk being added to the mixture just prior to discharge of the mixture from the opening.

The container may also include means to urge the wetted food mixture along the divider wall toward the discharge opening, particularly where especially sticky cereal is being consumed. For example, a weighted member may be slidably attached to the divider wall on the food side of the divider wall so that the member slides under the force of gravity in the direction of the discharge opening when the receptacle is tilted for consumption, and slides back toward the bottom of the receptacle when the receptacle is returned to its upright position. Alternatively, the divider wall may be pivotal to increase the angle as the receptacle is tilted. The divider wall may also be constructed of, or be surfaced with, a low friction material.

To improve ease of handling, a handle can extend outwardly from the side of the receptacle. Preferably, the handle is in the configuration of a longitudinal bar that is tilted forward at an angle of from about 45° to about 90° relative to the longitudinal axis of the receptacle, so that the handle is essentially horizontal when the receptacle is tilted at the proper angle for consumption. The handle may be located for right-handed or left-handed use.

The container lid may also include a closeable liquid port extending into the liquid side of the receptacle, enabling the user to drink the remaining liquid after the cereal has been consumed. The port may be sized for insertion of a straw into the liquid side of the receptacle.

To use the container, a quantity of cereal and milk is placed into the receptacle sufficient to fill about one-half or less of the receptacle interior. The lid is then placed onto the receptacle, inserting the divider wall into the receptacle so that the cereal is on the solids side of the receptacle. The receptacle may be tilted slightly if necessary, although the angularity of the divider wall assists in moving the cereal to the solids side of the divider wall.

In the receptacle, the cereal and milk mix together just as in a conventional cereal bowl, with a portion of the milk being absorbed by or entrapped within the cereal. When the consumer desires a mouthful of cereal, he or she tilts the receptacle so that excess milk, i.e., milk not absorbed by or held within the cereal, drains through the perforations in the lower section of the divider wall to the liquid side of the receptacle. As the consumer continues to tilt the receptacle past horizontal, the milk flows into the top part of the receptacle against the lid. At the same time, the wetted cereal from which excess milk has been removed slides downwardly along the divider wall, with a portion of the cereal being discharged through the discharge opening onto the mouthpiece to be eaten by the consumer.

The container may be reusable, or as a one-use, disposable container. If disposable, the container may be prepackaged with cereal, requiring only the addition of milk for consumption.

### BRIEF DESCRIPTION OF THE DRAWINGS

FIG. 1 is a perspective view of the container.

FIG. 2 is a side view of the lid with attached mouthpiece and divider wall.

FIG. 3 is a sectional side view of the lid with attached mouthpiece and divider wall.

FIG. 4 is a rear view of the lid with attached mouthpiece and divider wall.

FIG. 5 is a front view of the lid with attached mouthpiece and divider wall.

FIG. 6 is a sectional side view of the container containing milk and cereal when in the upright position.

FIG. 7 is a sectional side view of the container containing milk and cereal when in the horizontal position.

FIG. 8 is a sectional side view of the container containing milk and cereal when tilted beyond horizontal for consumption, the wet cereal mixture shown sliding down the divider wall with a portion being discharged through the discharge opening onto the mouthpiece for consumption.

FIG. 9 is a sectional side view of the upper part of the container illustrating a small port in the divider wall adjacent the interface of the wall and lid to allow milk to join with the wetted cereal before being discharged.

FIG. 10 is a sectional side view of the upper part of the container illustrating a closeable opening for use in drinking milk from the container after the cereal has been consumed.

FIG. 11 is a side view of the container with an attached handle.

FIG. 12 is a rear view of the container with an attached handle.

FIG. 13 is a top view of the lower part of the divider wall showing an optional cereal pushing member in the rearward position.

FIG. 14 is a top view of the lower part of the divider wall showing an optional cereal pushing member in the forward position.

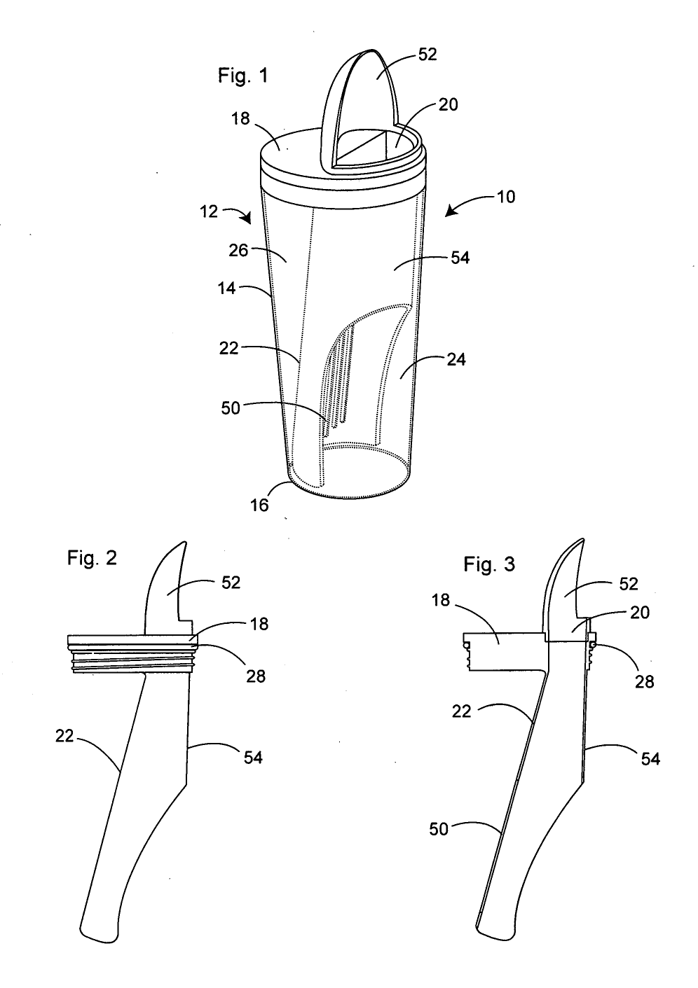

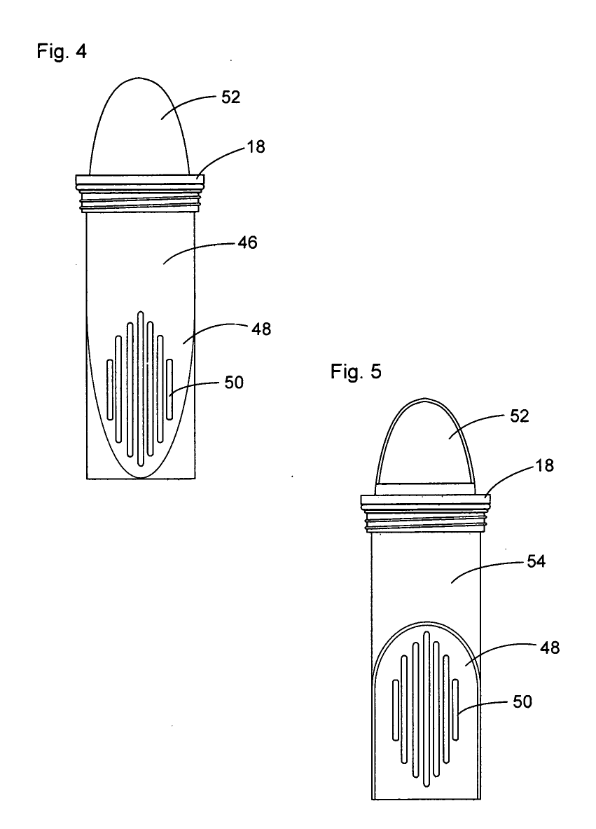

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

A preferred embodiment of the portable handheld container, generally 10, illustrated in the drawings, is comprised of an open-top receptacle, generally 12, having a continuous, downwardly tapered outer wall 14 and a bottom wall 16, a lid 18 with a cereal mixture discharge opening 20, and a divider wall 22 separating receptacle 12 into a solid side, shown as 24, and a liquid side, shown as 26.

Lid 18 extending across the top of receptacle 12 is a screw-off lid in the preferred embodiment. An O-ring 28 is positioned between lid 18 and receptacle 12 to provide a liquid tight seal. Lid 18 has an upper surface and a lower surface with discharge opening 20 extending through lid 18 into communication with solid side 24 of receptacle 12. Opening 20 is offset to adjacent the edge of lid 18 and has an inner side toward the center of lid 18 and an outer side toward the periphery of lid 18.

Divider wall 22 extends downwardly from the lower surface of lid 18 adjacent the inner side of lid 18 to adjacent bottom wall 16 to divide receptacle 12 into solids side 24 to hold the wetted cereal 42 or other dry food, and liquid side 26 to hold the milk 44 or other liquid food. Divider wall 22 has a liquid impermeable upper section 46 and a liquid permeable lower section 48 including vertical slots 50, which allow milk or other liquid to flow through divider wall 22 between sides 24 and 26, but prevents solids from passing from side 24 to the side 26. Sections 46 and 48 are of approximately equal length to ensure flow of excess milk 44 from side 24 of receptacle 12 during consumption, while avoiding any interference with the discharge of wetted cereal 42.

For convenience in consumption and to simulate eating of cereal from a bowl, a spoon-shaped mouthpiece 52 is attached to the upper surface of lid 18 along the inner side of discharge opening 20. Wetted cereal 42 discharged from discharge opening 20 is then deposited onto the “spoon” mouthpiece 52 where it is eaten by the consumer in the normal way cereal is eaten.

In other to facilitate the discharge of wetted cereal 42 from receptacle 12, and to isolate excess milk 44 from the wetted cereal 42, an outwardly curved barrier wall 54 extends downwardly from outer side of discharge opening 20 and across upper section 46 of divider wall 22. The side edges of barrier wall 54 joins the side edges of divider wall upper section 46 to form a conduit extending from approximately half way into receptacle 12 to around discharge opening 20.

In order to maximize the amount of wetted cereal 42 that can be held in receptacle 12, divider wall 22 is preferably angled toward liquid side 24 of receptacle 12 at an angle of up to about 45°, and preferably from about 20° to about 45°, relative to the longitudinal axis of receptacle 12. At this angle, sufficient wetted cereal can be placed on solids side 24 of divider wall 22 in the bottom of receptacle 12, while still enabling wetted cereal 42 to slide along the solids side 24 of divider wall 22 when receptacle 12 is tilted for consumption.

As noted previously, the upper edge of divider wall 22 is integral with the lower surface of lid 18 adjacent the inner edge of discharge opening 20. Since discharge opening 20 is offset toward the edge of lid 18, the upper edge of divider wall 22 will also be offset toward liquids side 26 of receptacle 12. As a result, additional space is provided in the upper part of receptacle 12 on liquid side 26 to hold excess milk 44 when receptacle 12 is tilted for consumption.

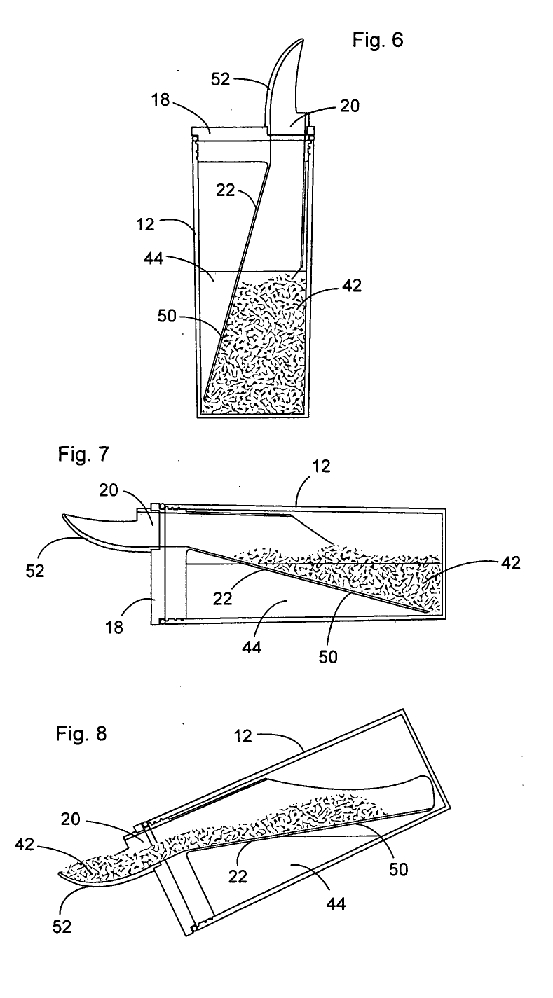

To use container 10, a quantity of cereal and milk is placed into receptacle 12 sufficient to fill about one-half of the interior of receptacle 12. Lid 18 is then placed onto receptacle 12, inserting divider wall 22 into receptacle 12 so that wetted cereal 42 is on solids side 24 of receptacle 12. See FIG. 6. In receptacle 12, the cereal and milk mix together just as in a conventional cereal bowl, with a portion of the milk being absorbed by and entrapped within the cereal.

When the consumer desires a mouthful of cereal, he or she tilts receptacle 12 so that excess milk 44, i.e., milk not absorbed or held within the cereal, drains through slots 50 in the lower section of divider wall 48 to the liquid side 26 of the receptacle. See FIG. 7.

As the consumer continues to tilt receptacle 12 past horizontal, milk 44 flows into the top part of receptacle 12 against lid 18. At the same time, wetted cereal 42 from which excess milk 44 has been removed, slides downwardly along divider wall 22, with a portion of the cereal being discharged through discharge opening 20 onto mouthpiece 52 to be eaten by the consumer.

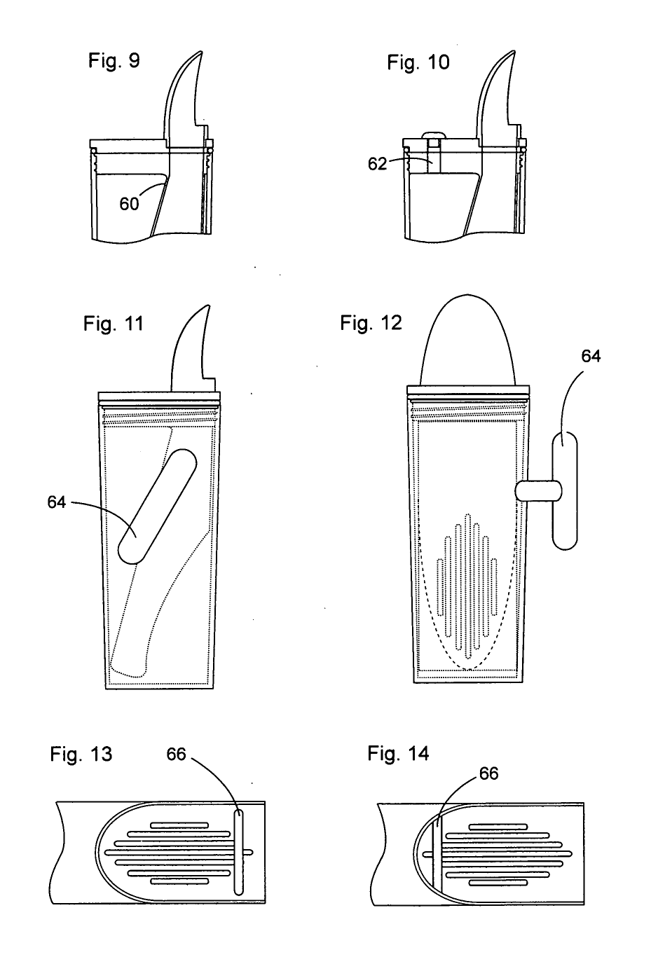

Container 10 may also incorporate several optional features to enhance consumption. For example, when there is a desire to add an additional amount of milk to the mixture being discharged, a small liquid opening 60, as illustrated in FIG. 9, may be included in divider wall 22 adjacent the interface of divider wall 22 and lid 18. Thus, when receptacle 12 is tilted for consumption, the wetted cereal 42 slides along divider wall 22 and out discharge opening 20, with a small amount of additional milk being added to cereal 42 just prior to discharge of cereal 42 from opening 20. The term “solid section” or “impervious section” when describing the upper section of the divider wall broadly includes sections with or without liquid opening 60.

Lid 18 may also include a closeable liquid port 62, as illustrated in FIG. 10, providing access to liquid side 26 of receptacle 12, enabling the user to drink the remaining liquid after the cereal has been consumed. Port 62 may be sized for insertion of a straw into liquid side 26 of receptacle 12.

To improve ease of handling, a handle 64, as illustrated in FIGS. 11 and 12, can be attached to the side of receptacle 12. Preferably, handle 64 is in the shape of a longitudinal bar that is tilted forward at an angle at the top end of from about 45° to about 90° relative to the longitudinal axis of receptacle 12, so that handle 64 is essentially horizontal when receptacle 12 is tilted for consumption.

Container 10 may also include means to urge wetted cereal 42 along divider wall 22 toward discharge opening 30, particularly where especially sticky cereal is being consumed. For example, a weighted member 66 may be slidably attached to divider wall 22 on food side 24 of divider wall 22 so that member 66 slides under the force of gravity in the direction of discharge opening 30 when receptacle 12 is tilted for consumption, and slides back toward the bottom of receptacle 12 when receptacle 12 is returned to its upright position.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A portable hand-held food container for use in holding a food mixture of a solid and a liquid, and for consuming said mixture with excess liquid being separated from said mixture prior to consumption comprising:
a) an open-top receptacle having an outer wall and a bottom wall, a solids side, and a liquid side;
b) a lid having an upper surface, a lower surface, and a discharge opening in communication with the receptacle solids side, said opening having an inner side and an outer side; and
c) a divider wall extending downwardly from the bottom surface of said lid adjacent the inner side of said discharge opening between said receptacle solid and liquid sides, said divider wall having openings permitting liquid to flow through the divider wall between the solid and liquid sides, but preventing solids from passing from the solid side to the liquid side.

2. The container of claim 1, further including a spoon-shaped mouthpiece attached to the upper surface of said lid to receive material discharged from said discharge opening.

3. The container of claim 1, further including an outwardly curved barrier wall extending downwardly from the outer side of said top opening and across the upper section of said divider wall, said barrier wall outer edges joining the outer edges of said divider wall upper section to form a conduit extending to said discharge opening.

4. The container of claim 1, wherein said divider wall includes a solid upper section and a liquid permeable lower.

5. The container of claim 1, wherein said divider wall is angled toward the solids side of said wall at an angle of from about 20° to about 45° relative to the longitudinal axis of said receptacle.

6. The container of claim 1, wherein divider wall includes a liquid port adjacent its upper edge.

7. The container of claim 1, further including means to urge a food mixture along the solids side of said divider wall toward said top opening and into said mouthpiece.

8. The container of claim 1, further including a handle extending outwardly from the side of said receptacle.

9. The container of claim 1, wherein said top further includes a closeable liquid port in communication with the liquid side of said receptacle.

10. A portable hand-held food container for use in holding a cereal mixture of a cereal and milk, and for consuming said mixture with excess milk being separated from said mixture prior to consumption comprising:
a) an open-top receptacle having an outer wall and a bottom wall, a cereal side, and a milk side;
b) a lid having an upper surface, a lower surface, and a discharge opening in communication with the receptacle cereal side, said opening having an inner side and an outer side;
c) a spoon-shaped mouthpiece attached to the top surface of said lid along the inner side of said discharge opening; and
d) a divider wall extending downwardly from the bottom surface of said top adjacent the inner side of said discharge opening between said receptacle cereal and milk sides, said divider wall having openings permitting milk to flow through the divider wall between the cereal and milk sides, but preventing cereal from passing from the cereal side to the milk side.

11. The container of claim 10, further including an outwardly curved barrier wall extending downwardly from the outer side of said top opening and across the upper section of said divider wall, said barrier wall outer edges joining the outer edges of said divider wall upper section to form a conduit extending to said top opening.

12. The container of claim 10, wherein said divider wall has a solid upper section and a liquid permeable lower section.

13. The container of claim 10, wherein said divider wall is angled downwardly toward the liquid side of said wall at an angle of from about 20° to about 45° relative to the longitudinal axis of said receptacle.

14. The container of claim 10, further including a handle extending outwardly from the side of said receptacle.

15. A method of consuming a food mixture of a solid and a liquid with separation of excess liquid prior to consumption comprising:
a) providing a receptacle having a lid with a discharge opening and solids and liquid sides;
b) providing a divider wall separating said solids and liquid sides, said wall permitting liquid to flow between the solids and liquid sides, but preventing solids from passing from the solids side to the liquid side, said discharge opening being in communication with the solids side;
c) partially filling the receptacle with a solid food and liquid food, whereby the liquid and solid foods admix so that the solid food is wetted by the liquid food within the solids side of the receptacle;
d) tilting the receptacle whereby excess liquid drains to the liquid side and wetted solid food slides along the surface of said divider wall and through said discharge opening for consumption.

16. The method of claim 15, wherein the solid is cereal and the liquid is milk.

17. The method of claim 15, wherein the receptacle is tilted at an angle greater than 90° to consume said wetted food mixture.

18. The method of claim 15, further including the step of providing a spoon shaped mouthpiece on said top in communication with said opening, said wetted food sliding through said opening and onto said mouthpiece for consumption.

19. The method of claim 15, wherein said divider wall is angled downwardly toward the liquid side of said receptacle at an angle of from about 20° to about 45° relative to the longitudinal axis of said receptacle.

20. The method of claim 15, further including providing an outwardly curved barrier wall extending downwardly from the outer side of said top opening and across the upper section of said divider wall, said barrier wall outer edges joining the outer edges of said divider wall upper section to form a conduit extending to said discharge opening.
